(19) United States
(12) Patent Application Publication
(10) Pub. No.: US 2005/0037731 A1
(43) Pub. Date: Feb. 17, 2005

(54) Cellular telephone billing methods

(76) Inventors: Jean E. Whewell, Georgetown, TX (US); Christopher J. Whewell, Georgetown, TX (US)

Correspondence Address: Christopher J. Whewell, 6020 Tonkowa Trail, Georgetown, TX, 78628, US

(21) Appl. No.: 10/946,139

(22) Filed: Sep. 21, 2004

Related U.S. Application Data
(63) Continuation-in-part of application No. 10/230,852, filed on Aug. 29, 2002.
(63) Continuation-in-part of application No. 10/876,938, filed on Jun. 26, 2004.
(63) Continuation-in-part of application No. 10/940,208, filed on Sep. 14, 2004.

(51) Int. Cl. H04M 11/00

(52) U.S. Cl. 455/406; 455/405

(57) ABSTRACT

Provided herein are billing methods for cellular service providers to offer customers which take into account the fact that an individual's use varies from one service interval to the next, and has the net effect of reducing the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of the threshold minutes.

### CROSS-REFERENCES TO RELATED APPLICATIONS

This application is a continuation-in-part of U.S. patent application Ser. No. 10/230,852 filed on Aug. 29, 2002, of U.S. patent application Ser. No. 10/876,938 filed Jun. 26, 2004, and of U.S. patent application Ser. No. 10/940,208 filed Sep. 14, 2004 the entire contents each of which are herein incorporated by reference.

### TECHNICAL FIELD

This invention relates to cellular telephone service and billing plans useful by providers of such service to invoice their customers for such service.

### BACKGROUND

Cellular telephone services are in widespread use. Providers of such services offer different billing plans to prospective customers under which the different plans have differing amounts of threshold levels of minutes that a user may consume for a flat fee. If the user exceeds the threshold amount of plan minutes within a given billing cycle, the user must pay a rate per minute for minutes in excess of the plan amounts. Often, the rate per minute for minutes used in excess of the plan threshold level of minutes is punitive in a sense that it is much higher than the rate per minute calculated from the basic plan amount divided by the number of threshold minutes provided under such a plan. This puts the consumer at a disadvantage as far as cost is concerned with respect to minutes consumed beyond the plan amount, and my cause negative feelings in the mind of the consumer towards the service provider, thus causing the consumer to break a contract or to seek alternative sources of cellular services after expiry of a contract. What is needed therefore, is a billing plan which does not penalize consumers for excessive use of cellular services and which increases consumer loyalty to a provider of cellular services.

### BRIEF DESCRIPTION OF THE DRAWINGS

In the annexed drawings,

FIG. 1 shows a graph of an effective billing curve for a billing plan of the prior art;

FIG. 2 shows a graph of an effective billing curve for a billing plan of the prior art;

FIG. 3 shows a graph of an effective billing curve for a billing plan of the prior art;

FIG. 4 shows a graph of an effective billing curve for a billing plan of the prior art;

FIG. 5 shows a graph of an effective billing curve for a billing plan of the prior art;

FIG. 6 shows the effective billing curves from the plans of prior art from FIGS. 1-5 superimposed on the same graph;

FIG. 7 shows a graph of an effective billing curve for a billing plan of the prior art;

FIG. 8 shows the effective billing curves from the plans of prior art from FIGS. 1-5 and FIG. 7 superimposed on the same graph;

FIG. 9 shows an effective billing line of a method according to the present invention; and

FIG. 10 shows a flowchart of the process of a method according to one embodiment of the present invention.

### SUMMARY OF THE INVENTION

The present invention provides a variable billing plan method for calculating an invoice amount for a consumer of cellular telephone services during a service interval. A method according to the invention comprises the steps of: a) offering a consumer a plurality of billing schedules from which to choose, wherein each of the schedules includes a pre-determined threshold level of given plan minutes which are billed at a flat rate and a rate per minute for each minute of service used which exceeds the threshold level, and wherein each of the plurality of billing schedules offered includes a different amount of pre-determined threshold level of given plan minutes: b) accepting a billing schedule choice selection from the consumer, wherein the choice includes a pre-determined threshold level of given plan minutes which are billed at a flat rate and a rate per minute for each minute of service used which exceeds the threshold level; c) providing cellular telephone service to the consumer during a service interval; d) calculating an invoice amount based upon the accepted billing schedule choice by combining the total dollar values of the flat rate and an addend that is calculated by multiplying the number of minutes of service used that exceed the threshold level by the rate per minute charged for each minute exceeding the threshold level; e) calculating a hypothetical invoice amount based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected; f) repeating step e) for each of all of the plans offered but not selected, so as to provide a hypothetical invoice amount for each plan not selected; g) comparing the hypothetical invoice amount(s) with the invoice amount from step d) to determine which out of all of the invoice amount and the hypothetical invoice amount(s) is the least dollar value; and h) issuing an invoice to the customer using the least dollar value as a pre-tax basis for the invoice.

### DETAILED DESCRIPTION

Cellular service providers offer the public different billing plans from which each individual user may choose, which best suits their personal calling needs. Typically, such services offer several different billing schedules to prospective customers to entice them to enter into contractual obligations with the service provider. Typically, the billing schedules offered include a pre-determined threshold level of minutes that the consumer may use, in exchange for a flat billing amount. In the event that the consumer utilizes more minutes of cellular service than specified as the predetermined threshold level, the consumer is billed on a per-minute basis for each minute in excess of the threshold level of minutes in the plan accepted by the consumer. The invoice at the end of the service interval, which is typically monthly, is calculated by adding the total dollar values of the flat rate and an addend that is calculated by multiplying the number of minutes of service used that exceed the threshold level by the rate per minute charged for each minute exceeding the threshold level. Taxes and other fees may then be added on and a final invoice amount is billed to the consumer.

A typical offering of a plurality of billing schedules is set forth below in Table I:

TABLE I
common plurality of billing schedule options offered to
consumers of cellular service.

| | Monthly | Threshold | Additional |
|---|---|---|---|
| Plan | Service | Level of | Minutes |
| Number | Charge | Minutes | Cost |
| 1 | $ 34.99 | 300 | 40 cents |
| 2 | $ 49.99 | 500 | 40 cents |
| 3 | $ 74.99 | 1000 | 40 cents |
| 4 | $ 99.99 | 1300 | 40 cents |
| 5 | $ 149.99 | 2200 | 40 cents |
| 6 | $ 199.99 | 3200 | 40 cents |

Thus, a consumer operating under plan 1 who used 400 minutes per service interval would be invoiced an amount equal to the monthly service charge of $34.99 plus an additional $40.00, derived from multiplying 100 minutes excessive of the threshold level of 300 minutes times the rate of 40 cents per minute.

Similarly, a consumer operating under plan 1 who used 600 minutes during the service interval would be invoiced based on an amount of $34.99 plus $120.00.

Certainly, it is to the consumer's advantage to select the plan which is well-suited to their individual needs. However, prediction of service usage by consumers is not always accurate due to fluctuating individual needs. If a cellular service provider were to offer their consumers and prospective consumers a variable rate billing plan which saved the consumer money during unpredictable fluctuations in their service, the consumer would appreciate the cost savings that such a variable billing plan would offer. A cellular service provider which offered a variable billing plan according to the invention would be very likely to attract customers away from their competition, and would appreciate significant long-term overall financial gains relative to their competition realized by an increased subscriber base, with relatively little increase in bandwidth usage.

According to the present invention the regular amount that a consumer would be billed under an accepted billing schedule is calculated. Then, a hypothetical invoice amount is calculated based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected. This is repeated for each of the plans that were offered but not selected, so as to provide a hypothetical invoice amount for each plan not selected. Then, the hypothetical invoice amount(s), (when more than two plans were offered to the consumer) are compared with the regular amount that the consumer would be billed under the accepted billing schedule (the “actual amount”)to determine which dollar value out of all of the hypothetical and actual amounts is the lowest cost to the consumer. The lowest value is selected as a basis for invoicing the customer, to which taxes and other customary fees are added to yield a final invoice amount which must be paid by the consumer.

In one preferred embodiment of the invention, in exchange for the valuable variable billing plan according to the invention, the consumer of cellular services is levied a surcharge on their invoice for the use of the variable plan.

Thus, a consumer of cellular services operating under plan 1 of Table I who uses 400 minutes in the service interval would have an actual amount for billing as set forth in Table III below next to plan 1, with the rest of the dollar values being the hypothetical invoice amounts:

TABLE II
Invoice amounts for person operating under plan 1 from
Table I who uses 400 minutes of service during
the service interval.

| Plan Number | Invoice Amounts |
|---|---|
| 1 | $ 74.99 (actual) |
| 2 | $ 49.99 (hypothetical) |
| 3 | $ 74.99 (hypothetical) |
| 4 | $ 99.99 (hypothetical) |
| 5 | $ 149.99 (hypothetical) |
| 6 | $ 199.99 (hypothetical) |

According to the present invention, the dollar figures from the right-hand column of Table II would be compared with one another to discover that the lowest dollar amount is $49.99. This is the amount which would be used as a basis for calculating the consumer's invoice, thus saving the consumer $30.00. The service provider, in one embodiment, would charge the consumer a surcharge for the use of a plan according to the present invention, which could be any amount between 0 and the amount saved. While it is most preferred that the surcharge is about one-half of the savings to the consumer, the present invention contemplates surcharges which are any dollar value between zero and the amount saved through use of the plan.

As another example, a consumer operating under plan 1 in Table I who uses 600 minutes of service would have an actual amount for billing as set forth in Table III below next to plan 1, with the rest of the dollar values being the hypothetical invoice amounts:

TABLE III
Invoice amounts for person operating under plan
1 from Table I who uses 600 minutes of
service during the service interval.

| Plan Number | Invoice Amounts |
|---|---|
| 1 | $ 154.99 (actual) |
| 2 | $ 89.99 (hypothetical) |
| 3 | $ 74.99 (hypothetical) |
| 4 | $ 99.99 (hypothetical) |
| 5 | $ 149.99 (hypothetical) |
| 6 | $ 199.99 (hypothetical) |

Thus, the lowest billing amount for a person operating under plan 1 who uses 600 minutes of service but calculated according to a method of the present invention would be $74.99. This could represent a maximum amount of savings of $80.00 to the consumer.

Use of a variable billing method according to the invention would not only attract consumers away from competitors in the cellular service market, but would also save consumers money while not adversely impacting bandwidth usage, all while increasing consumer loyalty.

Thus, as previously stated, it is an inherent feature of the present invention to take into account the fact that an individual's use varies from one service interval to the next, and to provide a billing method for cellular telephone services which is designed to automatically adjust the amount invoiced to the consumer based on the minutes of service actually consumed by a given consumer during a service interval so as to not penalize consumers for exceeding the threshold minutes of a plan to which they are contractually bound. According to the invention, the consumer's invoice is adjusted for a service interval so as to reduce the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of the threshold minutes.

The prior art of cellular telephone services billing has shown for years that different service providers each offer a plurality of plans from which consumers may choose, each of which plans contain various features, including differing levels of threshold minutes consumed and rates for minutes consumed in excess of the threshold values. Owing to each of such plans offered it is readily possible by simple mathematical calculation to arrive at a schedule, reminiscent of IRS tax schedules, of dollar amounts to be invoiced to a consumer for any number of minutes of service consumed during a service interval for each of the billing plans offered by a provider of cellular services.

While the mechanical step of a comparison between an actual invoice amount and a hypothetical invoice amount was specified in the foregoing disclosure, it is clear that such machinations are merely exemplary of specific embodiments of the broader scope of the concept taught by the present invention which are useful for arriving at the necessary result implicit in this disclosure—the automatic adjustment of the consumers invoice based on the consumption of the consumer (which often fluctuates) in a way which reduces the amount which the customer is invoiced within service intervals (and hence necessarily over a plurality of service intervals), as compared to billing plans of the prior art which feature a threshold level of minutes and a rate per minute for each minute consumed in excess of the threshold level. Therefore it is clear that the net result of the teachings of the principles of the present invention could lead to many situations in which substantially the same effective result is achieved using this same principle. The foregoing is illustrated by considering the information which was inherently contained in the plans originally provided in Table I of this disclosure. For each of these plans, one may readily graphically depict a billing line or billing curve path.

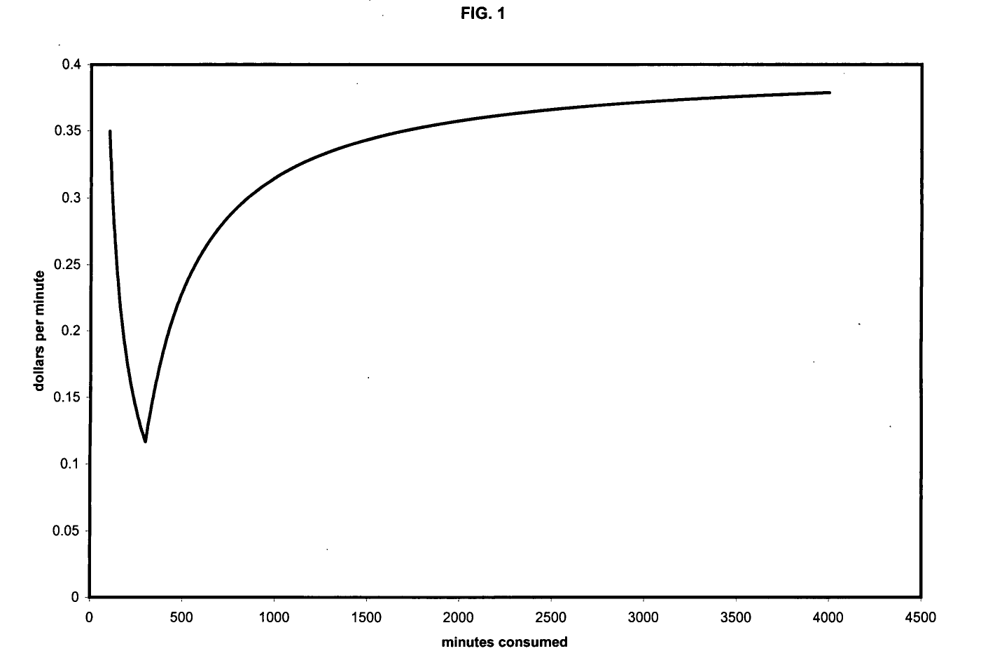

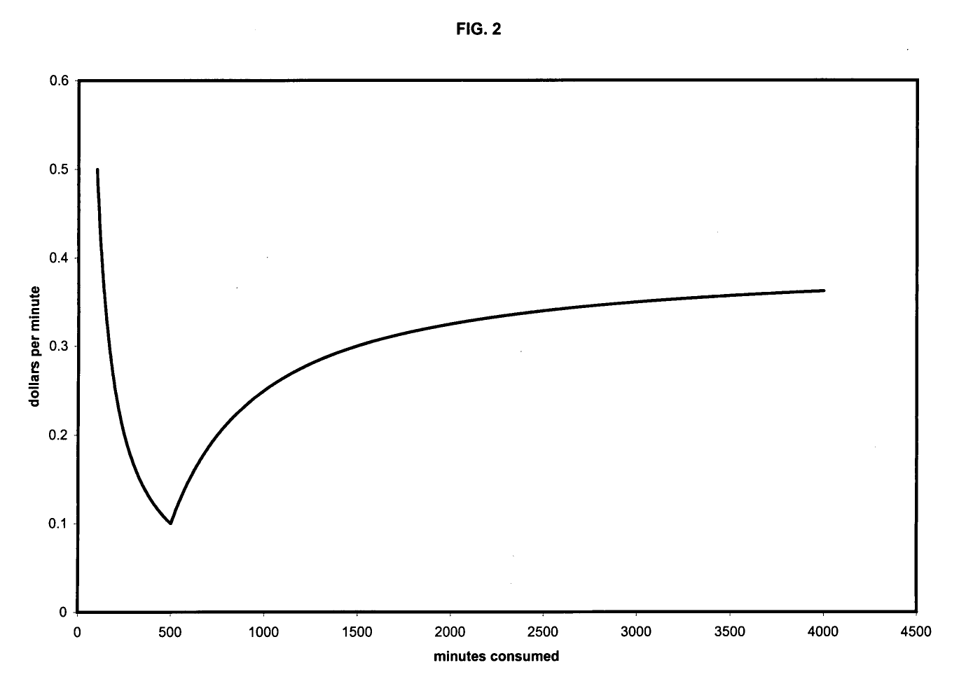

FIG. 1 provided herein is the effective billing curve of plan 1 set forth in Table I. Looking at the features of plan 1, as previously mentioned, for $34.99 the customer may consume up to 300 minutes of cellular service without incurring any additional charges. Beyond the 300 minute threshold they are billed at the specified rate per minute for each minute further consumed, which in the case of Table I is 40 cents per minute for each plan. Thus, it is a simple matter to generate the graph of FIG. 1, which shows the cost of cellular service, in terms of dollars per minute consumed, over the majority of common consumption ranges for plan 1. For the situation in which the customer chooses to only consume 1 minute of service for the month, in such case the effective rate per minute of the person's plan works out to be $34.99 per minute ! Consuming another minute within the month would cut the per minute rate in half, as the effective rate per minute is calculated by dividing the total amount of money invoiced by the number of minutes actually consumed. The trend in the cost per minute of cellular service for a person operating under plan 1 begins at $34.99 for one minute of service consumed, and continues to decrease, until the threshold level is reached, in this case 300 minutes. Minutes consumed in excess of 300 are then billed at the flat rate of 40 cents for each additional minute, which causes the consumers' overall rate per minute to climb once again, thus yielding the v-shaped graph of FIG. 1 having a minimum at 300 minutes consumed, with the y-axis being denominated in dollars per minute and representing the effective rate per minute charged to the customer, which is calculated by dividing the total dollars billed to the consumer for service by the total number of minutes consumed. Towards the left of the minimum, the effective rate per minute is calculated by dividing the total dollars invoiced for the monthly service by the number of minutes consumed ($34.99/x). Towards the right of the minimum, the effective rate per minute is calculated according to the formula:
((((x−300)*(0.4)))+34.99)/x
in which the asterisk (*) represents the multiplication operator and x represents the total number of minutes consumed. These formulae are inherent features of plan 1, as they are mathematically-equivalent expressions of plan 1. The range of minutes graphed in FIG. 1 was selected for convenience to be between 100 minutes and 4000 minutes, and it is a simple matter for one of ordinary skill to readily calculate and graph the entire range of effective dollar per minute values over the possible consumption of minutes values based on the plan information originally specified in Table I for every minute of service consumed within the universe of possible consumption, which is between 1 minute and the total number of minutes in a month or billing cycle. It is interesting to note that the minimum cost per minute for this plan is about 0.1166 dollars per minute, which occurs at the minima point. Below the minimum, the rate per minute is higher because the user did not use enough minutes, and beyond the minimum, the rate per minute is higher because the user used too many minutes. This depicts the punitive nature of cellular telephone billing plans of the prior art, and is general a characteristic of all of such prior art plans, including those in Table I.

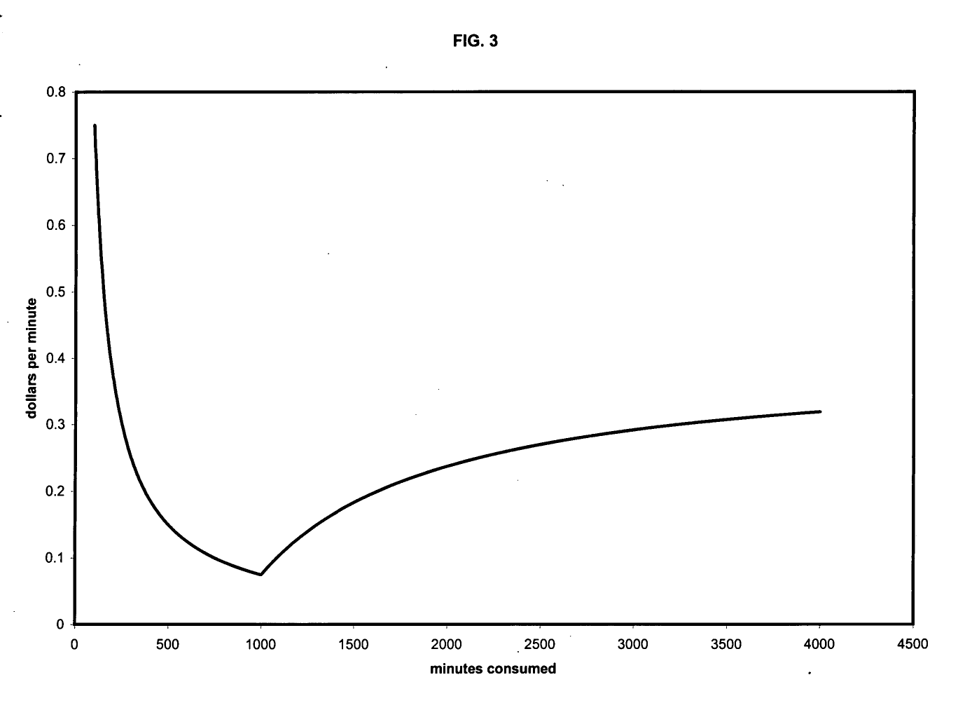

FIG. 2 shows graphically the effective billing curve of plan 2 set forth in Table I. Looking at the features of plan 2, for $49.99 the customer may consume up to 500 minutes of cellular service without incurring any additional charges. Beyond the 500 minute threshold they are billed at the specified rate per minute for each minute further consumed. Thus, it is a simple matter to generate the graph in FIG. 2, which shows the cost of cellular service, in terms of dollars per minute consumed, over the majority of common consumption ranges for plan 2. Again, the trend in the overall cost per minute of cellular service for a person operating under plan 2 continues to decrease with usage, until the threshold level of 500 minutes is reached. Minutes consumed in excess of 500 are then billed at the flat rate of 40 cents for each additional minute, which causes the consumers' overall rate per minute to climb once again, thus yielding the v-shaped graph of FIG. 2 having a minimum at 500 minutes consumed, with the y-axis being denominated in dollars per minute and representing the effective rate per minute charged to the customer. Towards the left of the minimum, the effective rate per minute is calculated by dividing the total dollars invoiced for the month by the number of minutes consumed ($49.99/x). Towards the right of the minimum, the effective rate per minute is calculated according to the formula:
((((x−500)*(0.4)))+49.99)/x
in which the asterisk (*) represents the multiplication operator and x represents the total number of minutes consumed. These formulae are inherent features of plan 2 as they are mathematically-equivalent expressions of plan 2. The range of minutes graphed in FIG. 2 was again selected for convenience, and it is a simple matter for one of ordinary skill to readily calculate and graph the entire range of effective dollar per minute values over the possible consumption of minutes values based on the plan information originally specified in Table I for every minute of service consumed within the universe of possible consumption.

FIG. 3 shows graphically the effective billing curve of plan 3 set forth in Table I. Looking at the features of plan 3, for $74.99 the customer may consume up to 1000 minutes of cellular service without incurring any additional charges. Beyond the 1000 minute threshold they are billed at the specified rate per minute for each minute further consumed. Thus, it is a simple matter to generate the graph in FIG. 3, which shows the cost of cellular service, in terms of dollars per minute consumed, over the majority of common consumption ranges for plan 3. Again, the trend in the overall cost per minute of cellular service for a person operating under plan 3 continues to decrease with usage, until the threshold level of 1000 minutes is reached. Minutes consumed in excess of 1000 are then billed at the flat rate of 40 cents for each additional minute, which causes the consumers overall rate per minute to climb once again, thus yielding the v-shaped graph or curve of FIG. 3 having a minimum at 1000 minutes consumed, with the y-axis being denominated in dollars per minute and representing the effective rate per minute charged to the customer. Towards the left of the minimum, the effective rate per minute is calculated by dividing the total dollars invoiced for the month by the number of minutes consumed ($74.99/x). Towards the right of the minimum, the effective rate per minute is calculated according to the formula:
((((x−1000)*(0.4)))+74.99)/x
in which the asterisk (*) represents the multiplication operator and x represents the total number of minutes consumed. These formulae are inherent features of plan 3 as they are mathematically-equivalent expressions of plan 3. The range of minutes graphed in FIG. 3 was again selected for convenience, and it is a simple matter for one of ordinary skill to readily calculate and graph the entire range of effective dollar per minute values over the possible consumption of minutes values based on the plan information originally specified in Table I for every minute of service consumed within the universe of possible consumption.

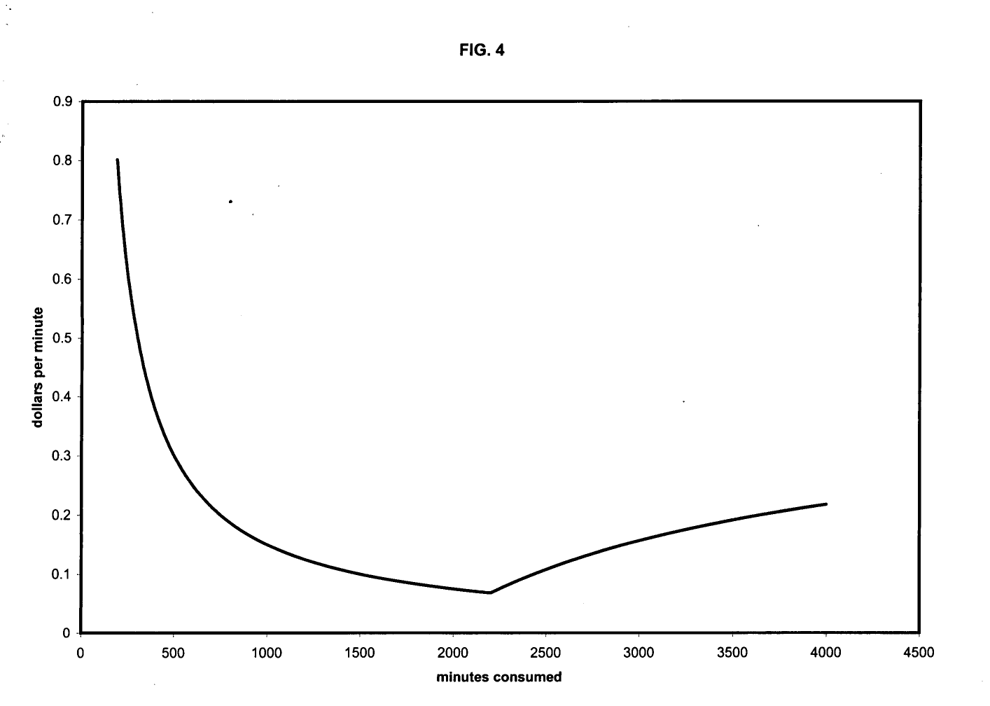

FIG. 4 shows graphically the effective billing curve of plan 5 set forth in Table I. Looking at the features of plan 5, for $149.99 the customer may consume up to 2200 minutes of cellular service without incurring any additional charges. Beyond the 2200 minute threshold they are billed at the specified rate per minute for each minute further consumed. Thus, it is a simple matter to generate the graph in FIG. 4, which shows the cost of cellular service, in terms of dollars per minute consumed, over the majority of common consumption ranges for plan 5. Again, the trend in the overall cost per minute of cellular service for a person operating under plan 5 continues to decrease with usage, until the threshold level of 2200 minutes is reached. Minutes consumed in excess of 2200 are then billed at the flat rate of 40 cents for each additional minute, which causes the consumers overall rate per minute to climb once again, thus yielding the v-shaped graph of FIG. 4 having a minimum at 2200 minutes consumed, with the y-axis being denominated in dollars per minute and representing the effective rate per minute charged to the customer. Towards the left of the minimum, the effective rate per minute is calculated by dividing the total dollars invoiced for the month by the number of minutes consumed ($149.99/x). Towards the right of the minimum, the effective rate per minute is calculated according to the formula:
((((x−2200)*(0.4)))+149.99)/x
in which the asterisk (*) represents the multiplication operator and x represents the total number of minutes consumed. These formulae are inherent features of plan 5 as they are mathematically-equivalent expressions of plan 5. The range of minutes graphed in FIG. 4 was again selected for convenience, and it is a simple matter for one of ordinary skill to readily calculate and graph the entire range of effective dollar per minute values over the possible consumption of minutes values based on the plan information originally specified in Table I for every minute of service consumed within the universe of possible consumption.

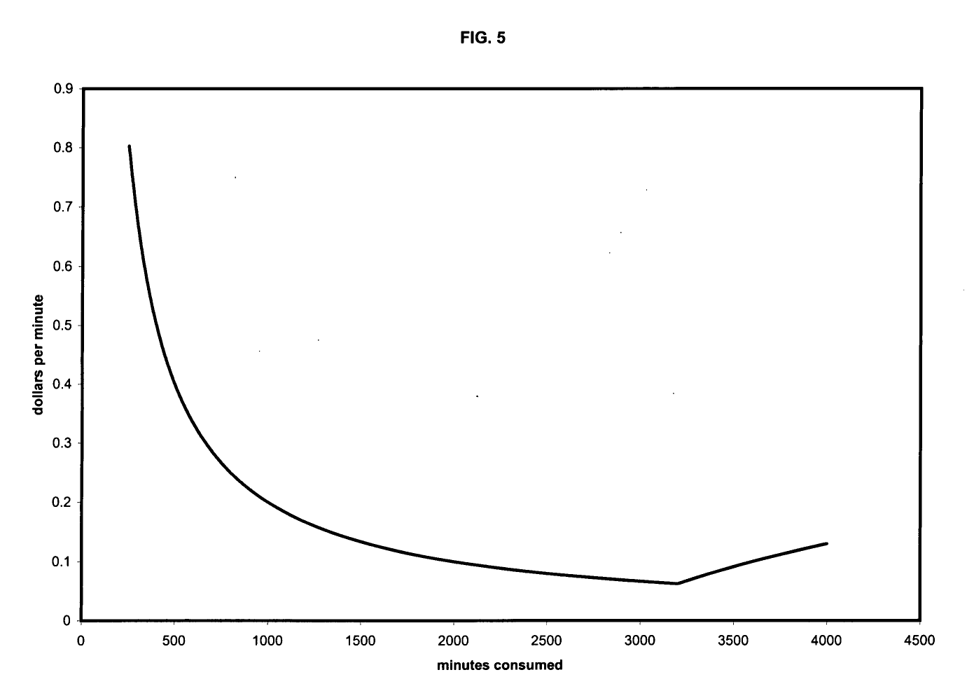

FIG. 5 shows graphically the effective billing curve of plan 6 set forth in Table I. Looking at the features of plan 6, for $199.99 the customer may consume up to 3200 minutes of cellular service without incurring any additional charges. Beyond the 3200 minute threshold they are billed at the specified rate per minute for each minute further consumed. Thus, it is a simple matter to generate the graph in FIG. 5, which shows the cost of cellular service, in terms of dollars per minute consumed, over the majority of common consumption ranges for plan 6. Again, the trend in the overall cost per minute of cellular service for a person operating under plan 6 continues to decrease with usage, until the threshold level of 3200 minutes is reached. Minutes consumed in excess of 3200 are then billed at the flat rate of 40 cents for each additional minute, which causes the consumers' overall rate per minute to climb once again, thus yielding the v-shaped graph of FIG. 5 having a minimum at 3200 minutes consumed, with the y-axis being denominated in dollars per minute and representing the effective rate per minute charged to the customer. Towards the left of the minimum, the effective rate per minute is calculated by dividing the total dollars invoiced for the month by the number of minutes consumed ($199.99/x). Towards the right of the minimum, the effective rate per minute is calculated according to the formula:
((((x−3200)*(0.4)))+199.99)/x
in which the asterisk (*) represents the multiplication operator and x represents the total number of minutes consumed. These formulae are inherent features of plan 6 as they are mathematically-equivalent expressions of plan 6. The range of minutes graphed in FIG. 5 was again selected for convenience, and it is a simple matter for one of ordinary skill to readily calculate and graph the entire range of effective dollar per minute values over the possible consumption of minutes values based on the plan information originally specified in Table I for every minute of service consumed within the universe of possible consumption for this plan.

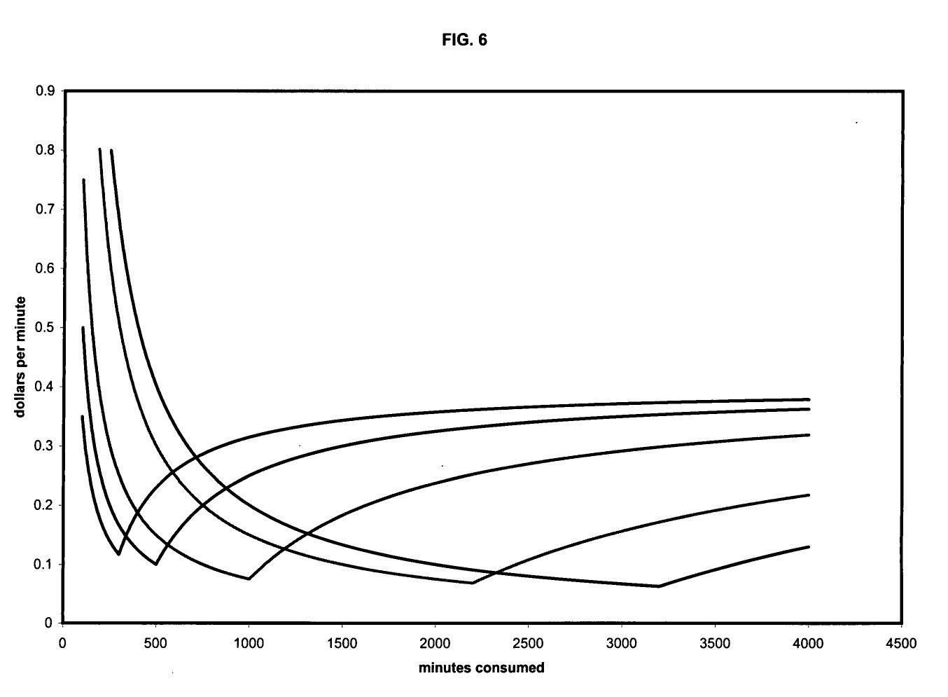

FIG. 6 shows graphically the effective billing curves for all of plans 1-4 and plan 6 superimposed on the same graph. It is noteworthy that all of the effective billing curves exist in the general form of a v, including a minimum value of dollars per minute billed for the service at a specific level of usage. Thus, for each prior art plan selected, the amount invoiced to the consumer on a per minute basis for cellular service within a service interval will be on a point on the graph representing the plan as in the foregoing examples, and that for plan 4 which now follows.

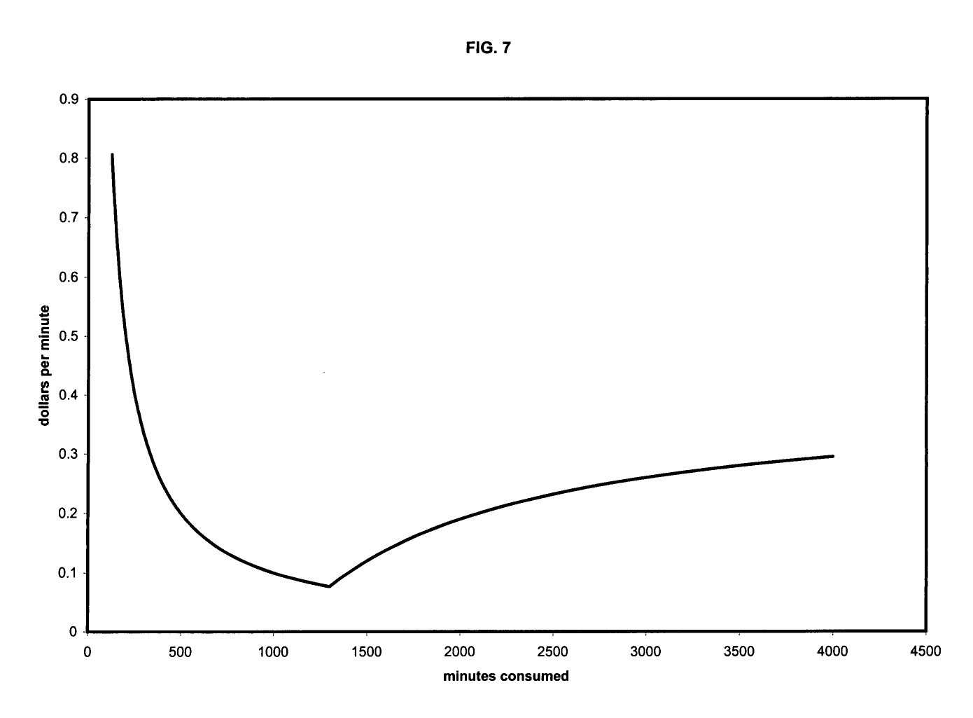

FIG. 7 shows graphically the effective billing curve of plan 4 set forth in Table I. Looking at the features of plan 4, one of ordinary skill immediately recognizes that for $99.99 the customer may consume up to 1300 minutes of cellular service without incurring any additional charges. Beyond the 1300 minute threshold they are billed at the specified rate per minute for each minute further consumed. Thus, it is a simple matter to generate the graph in FIG. 7, which shows the cost of cellular service, in terms of dollars per minute consumed, over the majority of common consumption ranges for plan 4. Again, the trend in the overall cost per minute of cellular service for a person operating under plan 4 continues to decrease with usage, until the threshold level of 1300 minutes is reached. Minutes consumed in excess of 1300 are then billed at the flat rate of 40 cents for each additional minute, which causes the consumers overall rate per minute to climb once again, thus yielding the v-shaped graph of FIG. 4 having a minimum at 1300 minutes consumed, with the y-axis being denominated in dollars per minute and representing the effective rate per minute charged to the customer. Towards the left of the minimum, the effective rate per minute is calculated by dividing the total dollars invoiced for the month by the number of minutes consumed ($99.99/x). Towards the right of the minimum, the effective rate per minute is calculated according to the formula:
((((x−1300)*(0.4)))+99.99)/x
in which the asterisk (*) represents the multiplication operator and x represents the total number of minutes consumed. These formulae are inherent features of plan 4 as they are mathematically-equivalent expressions of plan 4. The range of minutes graphed in FIG. 7 was again selected for convenience, and it is a simple matter for one of ordinary skill to readily calculate and graph the entire range of effective dollar per minute values over the possible consumption of minutes values based on the plan information originally specified in Table I for every minute of service consumed within the universe of possible consumption for this plan. The lowest cost per minute operating under plan 4 occurs at the minima, and is 0.0769 dollars per minute. This is higher than the lowest cost per minute when operating under plan 3, which occurs at the minima and is 0.0749 cents per minute.

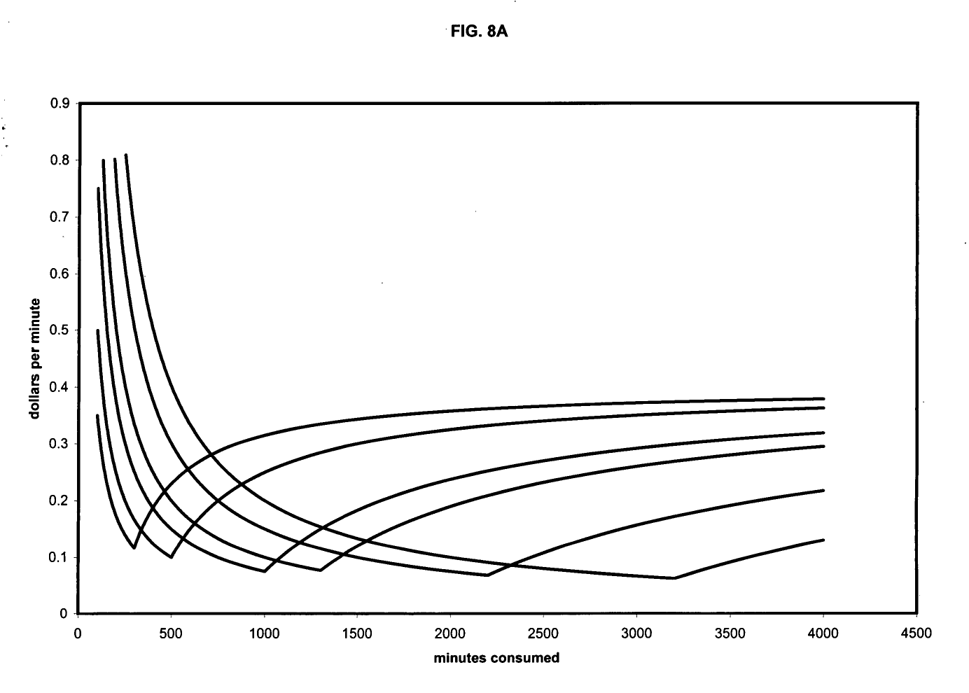

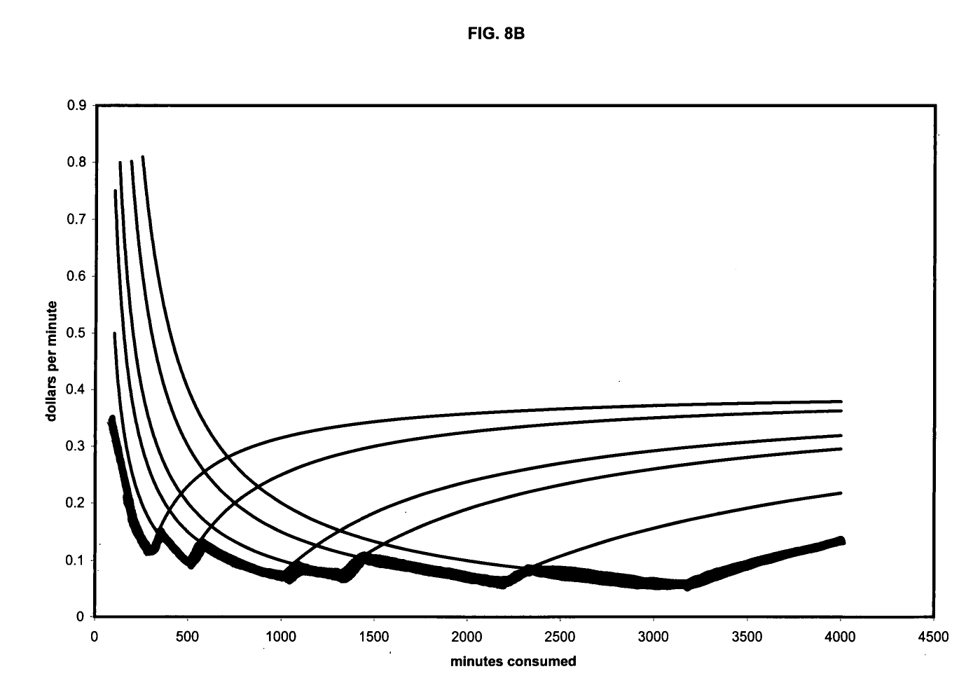

FIG. 8A shows graphically the effective billing curves for all of plans 1-6 from Table I superimposed on the same graph. These graphs are inherent features of all of the plans 1-6 in original Table I as they are mathematically-equivalent, graphical expressions of these plans. For each plan the amount an individual is billed for cellular service expressed in a dollars per minute be on the graph representing the plan they selected.

The inventive principle of the disclosure is now made readily visible by considering the heavy line in FIG. 8B. In this example, the heavy line in FIG. 8B contains points along all of the several billing graphs of plans 1-6 from Table I. This heavy line is arrived at by the teachings of paragraphs [0002] through [0017] above, i.e., by considering the invoice amount which a customer would have to pay under each of the plans for a given consumption level of minutes during the service interval, and selecting the plan having the lowest billing for that service interval out of all of the plans, over the entire range of possible consumption of minutes values within the service interval, monthly in Table I.

Thus, the heavy line in FIG. 8B represents the effective billing curve, line, or path of a person operating under a billing plan according to one form of the present invention, and constitutes a billing line graph generated using the principles of the present invention.

A graph having features comprised by the heavy line in FIG. 8B is what a cellular service provider obtains when it generates invoices according to a method according to one form of the present invention, as opposed to using methods of the prior art. The heavy line in FIG. 8B is thus a graphical equivalent rendering of the teachings of the present invention.

It is no accident that the effective billing graph of a billing method according to the invention is seen to resemble an L-shape over the range of consumption of 100 minutes of service to 3000 minutes of service, as opposed to billing methods of the prior art which generally contain a minimum feature over this same common range of minutes of consumption that causes the prior art graphs to resemble a v-shape.

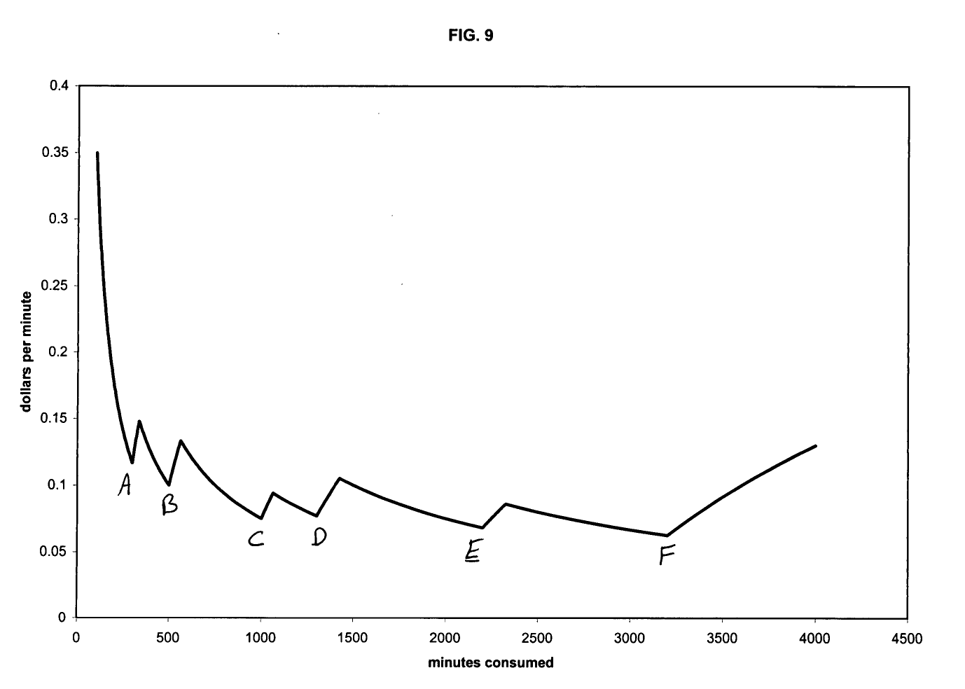

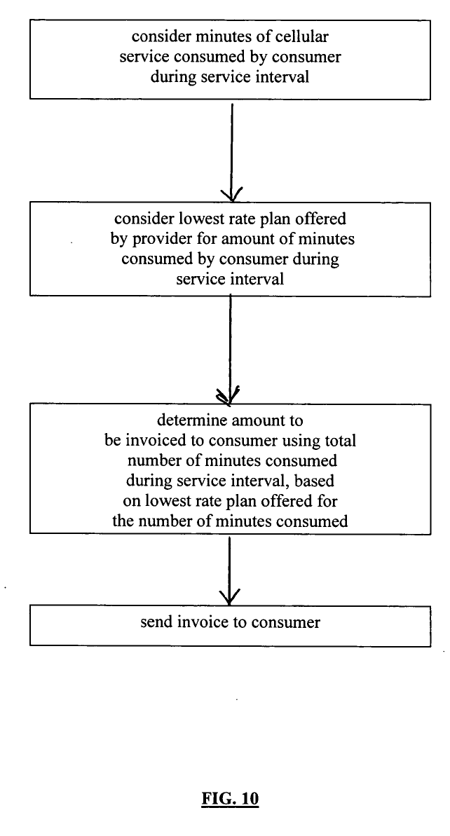

In FIG. 9 is shown the heavy line of FIG. 8B standing alone.

It is thus clear from the foregoing that a billing method according to this invention takes into account the minutes of cellular service consumed by a consumer during a service interval, and adjusts the amount of money invoiced to the consumer so as to reduce the total amount of money that the consumer is invoiced over a particular service interval and a plurality of service intervals, versus the amount the same consumer would have been otherwise invoiced for identical consumption over the same plurality of service intervals under a single plan featuring a fixed level of threshold minutes and a fixed rate per minute for each minute consumed in excess of said threshold minutes, having an effective billing curve having a single minima or discontinuity, and in which the effective billing rate per minute continuously increases after reaching the threshold level.

The effective billing line generated in accordance with the present invention and depicted in FIG. 9 includes a plurality of discontinuities, and some of these (labeled A, B, C, D, E, and F in FIG. 9) coincide with the minimums of each of the several billing plans from Table I. Thus, it is seen from FIG. 9 that the graph of the effective billing line of a billing plan according to the invention includes a plurality of discontinuity points (A, B, C, D, E, and F) wherein a second discontinuity point B has a y co-ordinate which is lower on the dollars per minute scale than a previous discontinuity point (A). It also includes subsequent discontinuity points (C), (E), (F) which are successively lower on the dollars per minute scale than previous discontinuity points.

The graphs in FIGS. 1-9 are seen to comprise curves and line segments, but all are considered to be billing line graphs for purposes of this specification and the appended claims. Billing line graphs and billing line curves are thus herein synonymous in the sense that they graphically represent the rate (in monetary units per minute) invoiceable over a range of consumption of minutes within a service interval.

From FIG. 9 it is seen that this invention thus provides a billing method for cellular telephone services which is structured such that the billing line graph generated using the inventive method includes a first discontinuity, a second discontinuity, and a third discontinuity, wherein the billing rate per minute at said first discontinuity is higher than the billing rate per minute at the second discontinuity, wherein said first discontinuity occurs at a lower consumption level of minutes than said second discontinuity, and wherein the billing rate per minute at said second discontinuity is higher than the billing rate per minute of the third discontinuity, wherein said second discontinuity occurs at a lower consumption level of minutes than said third discontinuity. For purposes of the present specification and the appended claims, a discontinuity is a point on the billing line graph at which the equation for determining the slope of the graph at a point and interval immediately after (greater consumption of minutes) the discontinuity is different than the equation for determining the slope of the graph at a point and interval immediately before (less consumption of minutes) the discontinuity. In FIG. 1, a discontinuity occurs at the consumption of 300 minutes of services, since the equation for calculating the slope at a point before the discontinuity is the first derivative of f(x)=34.99/x, or −x⁻², whereas the equation for calculating the slope at a point after the discontinuity is the first derivative of f(x)=(((x−300*(0.4))+34.99)/x, or 85.01x⁻⁻². Discontinuities occur at each of the points A, B, C, D, E, and F of FIG. 9.

It is seen that the minimum of dollars per minute for plan 4 occurs at a higher level than the minimum of dollars per minute from plans 4 and 5. Thus, considering FIG. 9 this invention also provides a billing method for cellular telephone services which is structured such that the billing line graph generated using the inventive method includes a first discontinuity, a second discontinuity, and a third discontinuity, wherein the billing rate per minute at said first discontinuity is higher than the billing rate per minute at the second discontinuity, wherein said first discontinuity occurs at a lower consumption level of minutes than said third discontinuity, and wherein the billing rate per minute at said second discontinuity is lower than the billing rate per minute of the third discontinuity, wherein said second discontinuity occurs at a lower consumption level of minutes than said third discontinuity.

The present invention further includes a data processing system for generating invoices for a plurality of cellular service consumers which comprises: a) computer processor means for processing data; b) storage means for storing data on a storage medium; c) first means for initializing the storage medium; d) second means for processing data regarding consumption of cellular service by said plurality of cellular service consumers; and e) third means for processing data so as to generate invoices to be billed to said plurality of cellular service consumers based on their consumption of cellular telephone services, wherein said third means causes the automatic adjustment of the amount of money to be invoiced to said consumers an effective amount so as to reduce said consumers invoice amounts to that of the lowest amount which would be due the provider under any one plan out of the plurality of billing plans offered by the provider, for the same consumption of minutes over the same service interval. Computer means for effecting such a processing system are well known in the art, and include those specified in U.S. Pat. No. 5,193,056, the entire contents of which are herein incorporated by reference. A personal computer may be used as part of a system according to the invention, such as a Sony VAIO® PCV-RX650 computer. Software useful to enable use of a system according to the is available from the present inventors, and may alternatively be carried out using the EXCEL® spreadsheet software available from Microsoft Corporation by entering the minutes of service consumed and in one embodiment calculating hypothetical invoice amounts for any plurality of plans selected and using the MIN function to determine the lowest billing or otherwise generate billing line graphs or “billing graphs” which include the characteristics herein described for billing plans according to this invention.

As mentioned, one goal of the present invention is to provide billing methods for cellular services which do not penalized the consumer for their unplanned use of cellular minutes. Towards this end, it is noticed that the points in FIG. 9 which are not labeled represent points at which the billing rate per minute falls once again after rising after a discontinuity point. In view of the foregoing discussion, it is now seen to be desirable to eliminate the peaks which occur between points A and B, points B and C, points C and D, points D and E, and points E and F. Doing so provides the market with a billing line graph which is a smooth line connecting A, B, C, D, E, and F and is of the general form k(1/x) in which k is in one embodiment a constant and is in another embodiment a variable. Thus, the present invention effectively provides cellular billing plans which have a substantially constant rate of billing on a per minute consumed basis over an extended range of the typical consumer's usage, in the range of between about 100 and about 3000 minutes per month, including all ranges within this range.

According to another embodiment of the invention, there is provided a billing plan for cellular telephone services which has a billing graph which displays a plurality of intervals of consumption in which the dollars per minute charged for the service in each interval is constant. In one embodiment, the rate for service in the range of 1-300 minutes consumed is billed at a first flat rate per minute, the rate for service in the range of 301-1000 minutes consumed is billed at a second flat rate per minute which is lower than the first flat rate, and the rate for service in the range of 1000-3000 minutes is billed at a third flat rate per minute which is lower than the second flat rate. Any number of such ranges may be contained within such a plan over the total minutes of consumption possible, and the range of minutes of service consumed at which each flat rate is applicable may be any range of consumption either specified by the provider, or selected by the consumer, i.e., the consumer may in one embodiment set the limits of their choice (as permitted by the provider) as a means for giving consumers more control over their plans.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. Accordingly, the presently disclosed invention is intended to cover all such modifications and alterations, and is limited only by the scope of the claims which follow.

1) A method of billing useful by a provider of cellular services in a market in which a plurality of billing plans are offered, which method takes into account the minutes of cellular service consumed by a consumer during a service interval and comprises the steps of:
a) providing a billing plan having a billing line graph which includes a first discontinuity and a second discontinuity, wherein the billing rate per minute at said first discontinuity is higher than the billing rate per minute at said second discontinuity, and wherein the first discontinuity occurs at a minutes of consumption level which is less than the minutes of usage at which said second discontinuity occurs;
b) providing cellular telephone service to the consumer over a service interval under said plan; and
c) charging the customer an invoice amount of at least the mathematical product of the number of minutes consumed by said consumer during said service interval multiplied by the dollars per minute cost of service associated with the level of consumption used by said consumer during said service interval on said billing line graph.

2) A method according to claim 1 wherein the service interval is any number of months in the range of 1 to 12.

3) A method according to claim 1 wherein the service interval is any time period between 1 month and 12 months, and the consumption of cellular service by said consumer is any number of minutes in the range of between about 300 and about 1000 minutes per month.

4) A method according to claim 1 wherein at least one of the billing plans offered by the provider has a billing graph which includes a single discontinuity.

5) A method according to claim 1 in which the effective billing rate per minute of at least one of the billing plans offered by the provider continuously increases after reaching a threshold level.

6) A method according to claim 1 in which the billing line graph does not display a continuous increase in dollars per minute of service as the consumption increases after exhibiting a first discontinuity, wherein said first discontinuity occurs at any point in the range of minutes consumed of about 100 minutes per month to about 2000 minutes per month.

7) A method according to claim 1 in which the billing line graph exhibits a plurality of regions in which the dollars per minute value decreases as more minutes are consumed, subsequent to a discontinuity in the billing line graph.

8) A method according to claim 1 in which the billing line graph includes a first discontinuity and a subsequent discontinuity, wherein the effective billing rate per minute at said first discontinuity is higher than that at the subsequent discontinuity, and wherein said first discontinuity occurs at a lower consumption level of minutes than said subsequent discontinuity.

9) A method according to claim 1 in which the billing line graph includes a first discontinuity a second discontinuity and a third discontinuity, wherein the billing rate per minute at said first discontinuity is higher than the billing rate per minute at the second discontinuity, wherein said first discontinuity occurs at a lower consumption level of minutes than said subsequent discontinuity, and wherein the billing rate per minute at said second discontinuity is higher than the billing rate per minute of the third discontinuity, wherein said second discontinuity occurs at a lower consumption level of minutes than said third discontinuity.

10) A billing plan for cellular telephone services which features a billing line graph which includes a first discontinuity and a second discontinuity, wherein the billing rate per minute at said first discontinuity is higher than the billing rate per minute at said second discontinuity, and wherein the first discontinuity occurs at a minutes of usage which is less than the minutes of usage at which said second discontinuity occurs.

11) A method of billing useful by a provider of cellular services in a market in which a plurality of billing plans are offered, which method takes into account the minutes of cellular service consumed by a consumer during a service interval and comprises the steps of:
a) providing a plan having a billing line graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at said third discontinuity; and
b) providing cellular telephone service to the consumer over a service interval under said plan; and
c) charging the customer an invoice amount of at least the mathematical product of the number of minutes consumed by said consumer during said service interval multiplied by the dollars per minute cost of service associated with the level of consumption used by said consumer during said service interval on said billing line graph.

12) A method according to claim 11 wherein the first discontinuity occurs at a minutes of consumption level which is less than the minutes of minutes of consumption level at which said second discontinuity occurs, and wherein the second discontinuity occurs at a minutes of consumption level which is less than the minutes of consumption level at which said third discontinuity occurs.

13) A method according to claim 11 wherein the first discontinuity occurs at a minutes of consumption level which is less than the minutes of minutes of consumption level at which said second discontinuity occurs, and wherein the third discontinuity occurs at a minutes of consumption level which is greater than the minutes of minutes of consumption level at which said first discontinuity occurs but is less than the minutes of consumption level at which said second discontinuity occurs.

14) A method according to claim 11 wherein the second discontinuity occurs at a minutes of consumption level which is less than the minutes of minutes of consumption level at which said first discontinuity occurs and wherein the third discontinuity occurs at a minutes of consumption level which is greater than the minutes of minutes of consumption level at which said first discontinuity occurs.

15) A billing plan useful for generating invoices under which customers of cellular telephone services may be billed which features a billing line graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at said third discontinuity.

16) A billing plan according to claim 15 wherein the level of minutes of cellular consumption at said first discontinuity is less than the level of minutes of cellular consumption at said second discontinuity, and wherein the level of minutes of cellular consumption at said second discontinuity is less than the level of minutes of cellular consumption at said third discontinuity.

17) A method according to claim 15 wherein the first discontinuity occurs at a minutes of consumption level which is less than the minutes of minutes of consumption level at which said second discontinuity occurs, and wherein the third discontinuity occurs at a minutes of consumption level which is greater than the minutes of minutes of consumption level at which said first discontinuity occurs but is less than the minutes of consumption level at which said second discontinuity occurs.

18) A method according to claim 15 wherein the second discontinuity occurs at a minutes of consumption level which is less than the minutes of minutes of consumption level at which said first discontinuity occurs and wherein the third discontinuity occurs at a minutes of consumption level which is greater than the minutes of minutes of consumption level at which said first discontinuity occurs.

19) A billing plan useful for generating invoices under which customers of cellular telephone services may be billed which features a billing line graph that exhibits a plurality of regions in which the dollars per minute value decreases subsequent to a discontinuity in the billing line graph, wherein said plurality of regions are separated by at least one discontinuity point.

20) A billing plan useful for generating invoices under which customers of cellular telephone services may be billed which features a billing line graph that exhibits a plurality of regions in which the dollars per minute value decreases subsequent to a discontinuity in the billing line graph, wherein said plurality of regions are separated by at least two discontinuity points.

21) A billing plan for cellular telephone services in which the rate charged per minute of service decreases continuously as the number of minutes consumed increases over the range of consumption between 300 minutes per month and 1000 minutes per month.

22) A billing plan for cellular telephone services in which the rate charged per minute of service is constant over the range of consumption between 300 minutes per month and 1000 minutes per month.

23) A data processing system useful for generating invoices for a plurality of cellular service consumers which comprises:
a) computer processor means for processing data;
b) storage means for storing data on a storage medium;
c) first means for initializing the storage medium;
d) second means for processing data regarding consumption of cellular service by said plurality of cellular service consumers; and
e) third means for processing data according to a billing plan having a billing line graph which includes a first discontinuity and a second discontinuity, wherein the billing rate per minute at said first discontinuity is higher than the billing rate per minute at said second discontinuity, and wherein the first discontinuity occurs at a minutes of consumption level which is less than the minutes of usage at which said second discontinuity occurs.

24) A data processing system useful for generating invoices for a plurality of cellular service consumers which comprises:
a) computer processor means for processing data;
b) storage means for storing data on a storage medium;
c) first means for initializing the storage medium;
d) second means for processing data regarding consumption of cellular service by said plurality of cellular service consumers; and
e) third means for processing data according to a billing plan having a billing line graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at said third discontinuity.

25) A method of advertising cellular telephone services which comprises the step of: offering a billing plan having a billing line graph which includes a first discontinuity and a second discontinuity, wherein the billing rate per minute at said first discontinuity is higher than the billing rate per minute at said second discontinuity, and wherein the first discontinuity occurs at a minutes of consumption level which is less than the minutes of usage at which said second discontinuity occurs.

26) A method of advertising cellular telephone services which comprises the step of: offering a billing plan having a billing line graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at said third discontinuity.

27) A method according to claim 26 wherein the level of minutes of cellular consumption at said first discontinuity is less than the level of minutes of cellular consumption at said second discontinuity, and wherein the level of minutes of cellular consumption at said second discontinuity is less than the level of minutes of cellular consumption at said third discontinuity.

28) A method according to claim 26 wherein the first discontinuity occurs at a minutes of consumption level which is less than the minutes of minutes of consumption level at which said second discontinuity occurs, and wherein the third discontinuity occurs at a minutes of consumption level which is greater than the minutes of minutes of consumption level at which said first discontinuity occurs but is less than the minutes of consumption level at which said second discontinuity occurs.

29) A method according to claim 26 wherein the second discontinuity occurs at a minutes of consumption level which is less than the minutes of minutes of consumption level at which said first discontinuity occurs and wherein the third discontinuity occurs at a minutes of consumption level which is greater than the minutes of minutes of consumption level at which said first discontinuity occurs.
